(19) United States
(12) Patent Application Publication
(10) Pub. No.: US 2003/0066075 A1
(43) Pub. Date: Apr. 3, 2003

(54) System and method for facilitating and controlling selection of TV programs by children

(76) Inventors: Catherine Bahn, Redmond, WA (US); Robert E. Novak, Kirkland, WA (US)

Correspondence Address: DIGEO, INC C/O STOEL RIVES LLP, 201 SOUTH MAIN STREET, SUITE 1100, ONE UTAH CENTER, SALT LAKE CITY, UT, 84111, US

(21) Appl. No.: 09/969,741

(22) Filed: Oct. 2, 2001

(51) Int. Cl. H04N 7/16; H04N 5/445

(52) U.S. Cl. 725/25; 725/32; 725/39; 725/50; 725/44

(57) ABSTRACT

In one embodiment, a system for an electronic program guide comprises a regular guide subsystem and a child-oriented guide subsystem. The system may periodically download child-friendly graphics, animation, and audio for display by the child-oriented guide subsystem. A child-oriented remote control that has fewer and larger buttons may be used to provide commands to the child-oriented guide subsystem. The system may include a text-to-speech conversion module utilized by the child-oriented guide subsystem to produce audible speech renderings of selective text information. A ratings-based blocking module under parental control may be used for automatically blocking objectionably-rated broadcast programs from being viewable by way of the child-oriented guide subsystem.

### BACKGROUND OF THE INVENTION

1. Field of the Invention

The present invention relates generally to software and television, and more particularly, to electronic guides to television programming.

2. Description of the Background Art

### BRIEF DESCRIPTION OF THE DRAWINGS

Non-limiting and non-exhaustive embodiments of the present invention are described in the Figures, in which

FIG. 1 is a schematic block diagram of a conventional video-casting network;

FIG. 2 is a diagram of a conventional interactive television client system;

FIG. 3 is a diagram of a conventional digital set top box;

FIG. 4 is a diagram of a television displaying a screen from a regular electronic program guide;

FIG. 5 is a schematic block diagram of a video-casting network in accordance with an embodiment of the invention;

FIG. 6 is an illustration of a first interactive television client system in accordance with an embodiment of the invention;

FIG. 7 is an illustration of a second interactive television client system in accordance with an embodiment of the invention;

FIG. 8 is an illustration of a television displaying a screen from a child-oriented electronic program guide in accordance with the invention;

FIG. 9 is a flow chart depicting a method for facilitating a child's selection of a television program for viewing from among available television programs in accordance with the invention;

FIG. 10 is an illustration of a third interactive television client system in accordance with an embodiment of the invention; and

FIG. 11 depicts example graphical icons for use in a child-oriented electronic program guide in accordance with the invention.

### DETAILED DESCRIPTION OF THE PREFERRED EMBODIMENTS

Systems and method are provided for overcoming the above-described problems and limitations of prior electronic program guides. In one embodiment, a system for an electronic program guide comprises a regular guide subsystem and a child-oriented guide subsystem. The system may periodically download child-friendly graphics, animation, and audio for display by the child-oriented guide subsystem. A child-oriented remote control that has fewer and larger buttons may be used to provide commands to the child-oriented guide subsystem. The system may include a text-to-speech conversion module utilized by the child-oriented guide subsystem to produce audible speech renderings of selective text information. A ratings-based blocking module under parental control may be used for automatically blocking objectionably-rated broadcast programs from being viewable by way of the child-oriented guide subsystem.

In the following description, numerous specific details are given to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

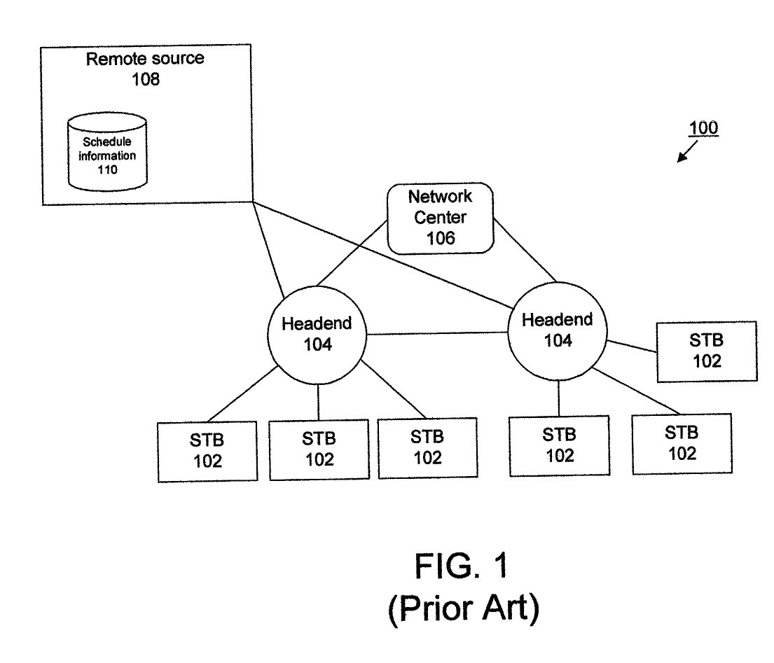

FIG. 1 is a schematic block diagram of a conventional video-casting network. The video-casting network depicted in FIG. 1 may comprise, for example, a cable network. The cable network 100 depicted in FIG. 1 includes a plurality of set top boxes 102 (hereinafter STB 102) or other customer premises equipment (CPE) located, for instance, at customer homes. Generally, an STB 102 is consumer electronics device that serves as a gateway between a customer's television and a broadband communication network, such as a cable network. As its name implies, an STB 102 is typically located on top of, or in close proximity to, a customer's television.

In one embodiment, an STB 102 receives encoded video/audio signals (including television signals) from the network 100 and decodes the same for display on the television. Additionally, an STB 102 receives commands from a user (typically via a remote control) and transmits such commands back to the network 100.

In various embodiments, each STB 102 is connected to a head-end 104. In the context of cable network, a head-end 104 is a centrally located facility where digital and analog cable TV (CATV) channels are received from a local CATV satellite downlink and packaged together for transmission to customer homes. In this way, a head-end 104 functions as a local digital broadcast center.

Head-ends 104 may be coupled directly to one another or through a network center 106. In some cases, head-ends 104 may be connected via a separate network, one particular example of which is the Internet. Of course, the illustrated network topology is provided for example purposes only, and other network topologies may be used within the scope of the invention.

As described in detail hereafter, each STB 102 may be identified by a unique number, code or address, such as an IP (Internet Protocol) or MAC (media access control) address or the like. Thus, a user of one STB 102 may indicate an STB 102 to receive an audio or video transmission by specifying the corresponding address. The network 100 then routes the transmission to its destination using conventional techniques.

A remote source 108 may be coupled to the head-ends 104 (or alternatively to the network center 106). The remote source 108 may provide schedule information 110 relating to television programs by way of the head-ends 104 to the set top boxes 102. The schedule information 110 typically comprises program information per channel and per time slot. Typically, the schedule information is downloaded periodically (for example, once per day in the middle of the night) and each download typically covers an upcoming range of time, such as, for example, the upcoming two weeks. A conventional electronic program guide application on a set top box 102 is typically used to display the schedule information 110.

Alternatively to the cable network, other video-casting networks may be used in accordance with other embodiments of the invention. For example, satellite TV delivery systems may be used. A satellite TV delivery system may comprise a direct broadcast satellite (DBS) system. A DBS system may comprise a small 18-inch satellite dish (which is an antenna for receiving a satellite broadcast signal); a digital integrated receiver/decoder (IRD), which separates each channel, and decompresses and translates the digital signal so a television can show it; and a remote control. Programming for a DBS system may be distributed, for example, by multiple high-power satellites in geosynchronous orbit, each with multiple transponders. Compression (e.g., MPEG) is used to increase the amount of programming that can be transmitted in the available bandwidth.

A broadcast center may be used to gather programming content, ensure its quality, and transmit the signal up to the satellites. Programming may come to the broadcast center from content providers (CNN, ESPN, etc.) via satellite, fiber optic cable and/or special digital tape. Satellite-delivered programming is typically immediately digitized, encrypted and uplinked to the orbiting satellites. The satellites retransmit the signal back down to every earth-station—or, in other words, every compatible DBS system receiver dish at customers' homes and businesses.

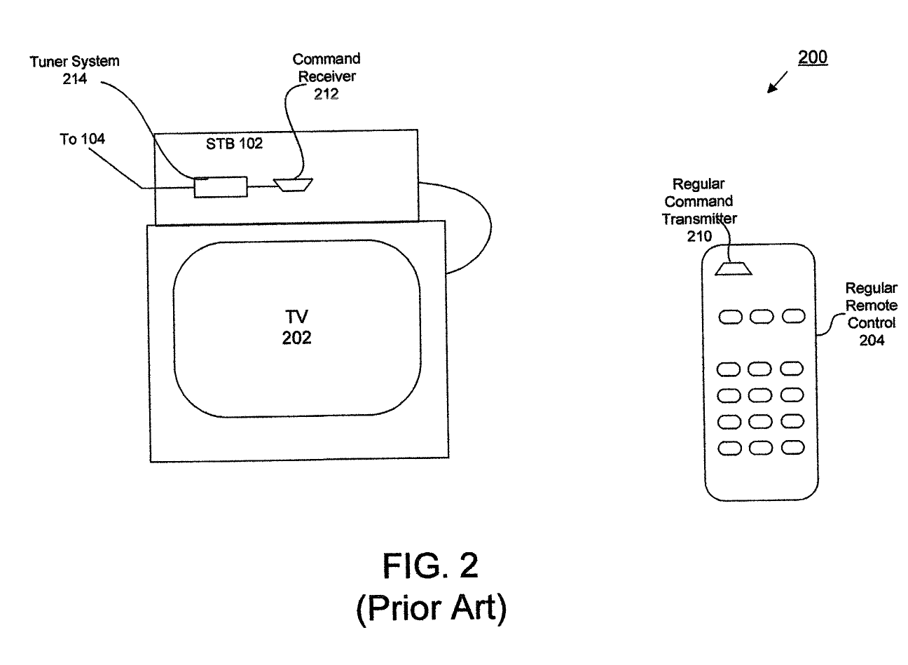

FIG. 2 is a diagram of a conventional interactive television client system. Various components of an interactive television client system 200 are depicted therein. The client system 200 preferably includes a television 202, which may receive and display television signals. In this embodiment, the client system 200 includes a STB 102 with a tuner system 214 for receiving and demodulating video, audio, and other data from the network 100.

The tuner system 214 may include a digital tuner configured to tune to a digital channel of the video casting network. Such digital channels typically broadcast compressed digital video to set top boxes. The tuner system 214 may also include an analog tuner configured to tune to an analog TV channel of the video casting network and to extract an analog TV signal therefrom. Such an analog tuner system makes the STB 102 “backward compatible” with analog TV broadcasts.

In one embodiment, a regular remote control 204 is provided for convenient remote operation of the STB 102 and the television 202. The regular remote control 204 depicted in FIG. 2 is simplified and for purposes of illustration only. Typical regular remote controls 204 for televisions or set top boxes have substantially more buttons than the one illustrated in FIG. 2. The regular remote control 204 may communicate with the advanced STB 102 and television 202 using conventional techniques to adjust, for example, the volume of the television, the displayed channel, and the like. Such communication may occur, for example, by way of control codes being transmitted from a command transmitter 210 on the regular remote 204 to a command receiver 212 on the STB 102. The transmitter 210 and receiver 212 may comprise, for example, infrared or radio frequency communication devices.

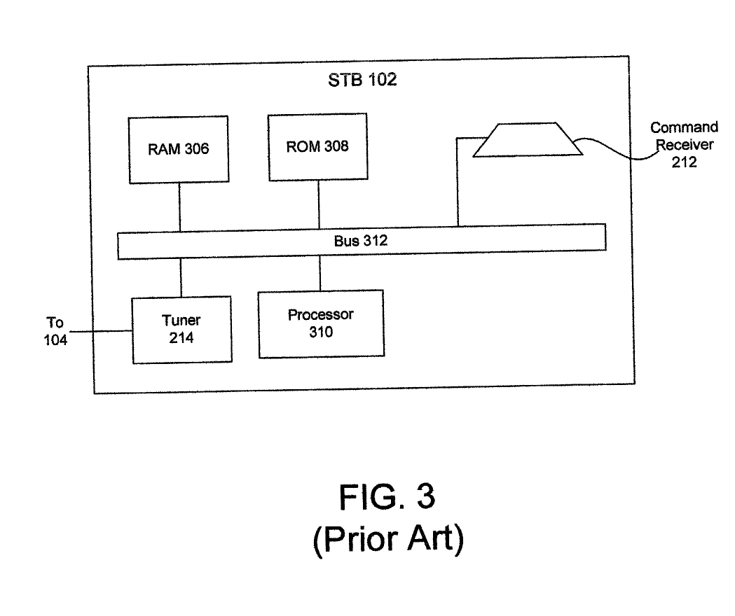

FIG. 3 is a diagram of a conventional set top box. Depicted therein are basic components of a STB 102. The configuration shown is for purposes of illustration and is not intended to be a detailed schematic of a STB 102. The STB 102 preferably includes a controller 310 that is in communication with the receiver 212, the tuner 214, a fixed digital storage system 302, RAM 306, and ROM 308. The controller 310 may be coupled to the other components of the STB 102, for example, via a bus 312.

In various embodiments, the controller 310 may be embodied as a microcontroller, a microprocessor, a digital signal processor (DSP) or other device known in the art. The controller 310 manages the operation of the STB 102, including, for example, the transmission and reception of video/audio/data information from the network 100, the storage of the video/audio/data information, and the like. As noted above, the controller 310 may perform these and other operations based on control signals generated by the remote control 204 and transmitted to the receiver 212.

The STB 102 may further include a random access memory (RAM) 306 configured to store data for temporary use. Similarly, a read-only memory (ROM) 308 may be provided for storing more permanent data, such as fixed code and configuration information. In one embodiment, the ROM 308 may be used to store an operating system for the STB 102, such as WINDOWS CE or LINUX operating systems.

In one embodiment, the STB 102 further comprises a conditional access (CA) system (not shown in the figure) coupled to the tuner system 214. The CA system restricts channels accessible by the device to authorized channels only. The CA system may be implemented using software and/or components available, for example, from MOTOROLA or SCIENTIFIC ATLANTA. A typical CA system operates in cooperation with a corresponding CA server in a cable head-end 104. In addition, the STB 102 may include a cable modem (not shown in the figure) coupled to the video casting network 100, typically coupling to the network 100 via the same RF cable as used to couple the tuner system 214 to the network 100. The cable modem is configured to receive digital data by demodulating an analog signal received from the network 100 and to transmit digital data by modulating the digital data to create an analog signal for transmission to the network 100. The cable modem may be implemented using, for example, the DOCSIS or DAVIC standards. A typical cable modem operates in cooperation with a cable modem termination system at a cable head-end 104.

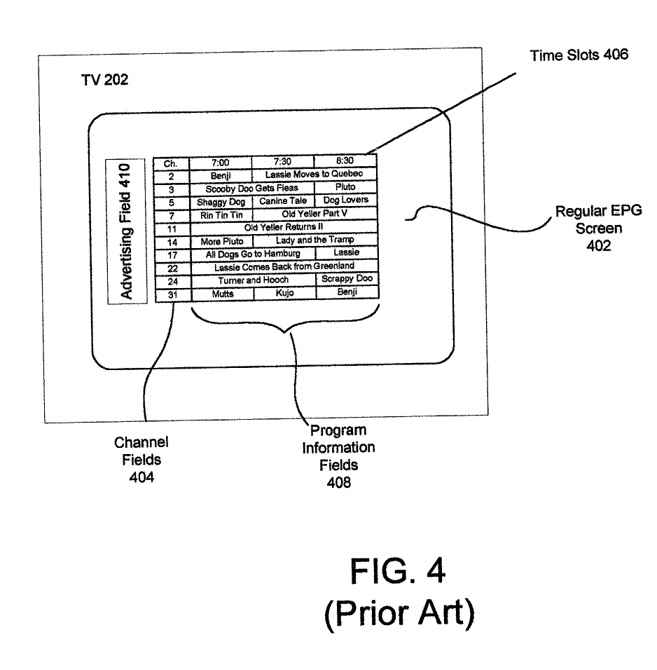

FIG. 4 is a diagram of a television displaying a screen from a regular electronic program guide (EPG). The screen shown is for purposes of illustration. A regular EPG 402 typically includes a grid having two axes, one for time slots 406, typically in half hour increments, and the other for channels or stations 404. Rectangular elements 408 formed within the grid are fields for information corresponding to specific television programs. A conventional EPG is available, for example, from Gemstar-TV Guide International, Inc. of Pasadena, Calif.

Generally, the navigation interface for a conventional EPG 402 is awkward and ill-suited to entertainment systems having more than a few channels. For example, a satellite STB may receive more than 500 channels, requiring the user to scroll through many pages of information to locate a desired program.

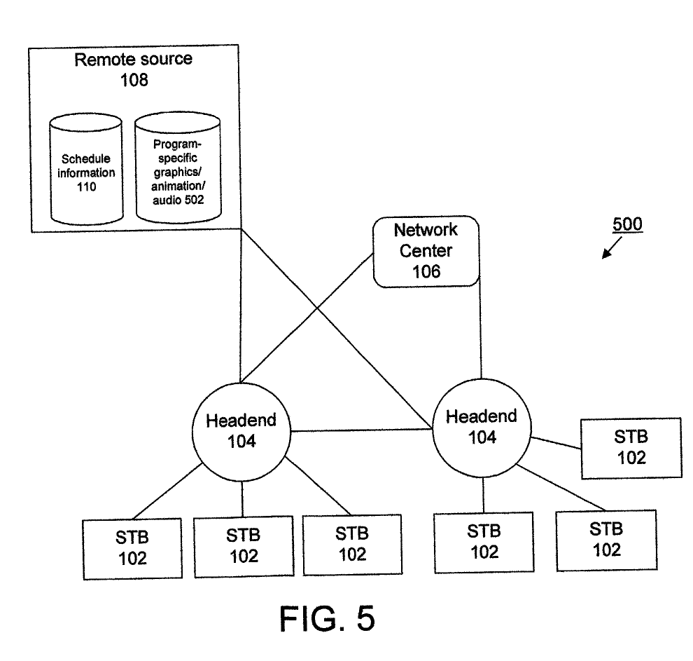

FIG. 5 is a schematic block diagram of a video-casting network in accordance with an embodiment of the invention. In comparison to the network 100 of FIG. 1, the network 500 depicted in FIG. 5 includes the additional element of program-specific content 502 at the remote source 108. Information is also provided by the remote source 108 to correlate the program-specific content 502 to the relevant television programs in the schedule information 110. In alternate embodiments, the program-specific content 502 may originate at a source that is separate from the source of the schedule information 110.

The program-specific content 502 may include program-specific graphics that are designed to be child-friendly. For example, the graphics may include graphical representations of television programs, such graphical representations being easily recognizable by children (whether or not the children are able to read yet).

The program-specific content 502 may also include program-specific animation that is designed to be child-friendly. The animation may be implemented, for example, using MACROMEDIA FLASH animation. As one example, the graphical representations of television programs may be animated to become animated graphical representations of the television programs. Such animation would further enliven a child-oriented electronic program guide screen.

In addition, the program-specific content 502 may include program-specific audio that is designed to be child-friendly. For example, the audio may be correlated to a particular animation on the child-oriented electronic program guide screen to enhance its child-friendliness.

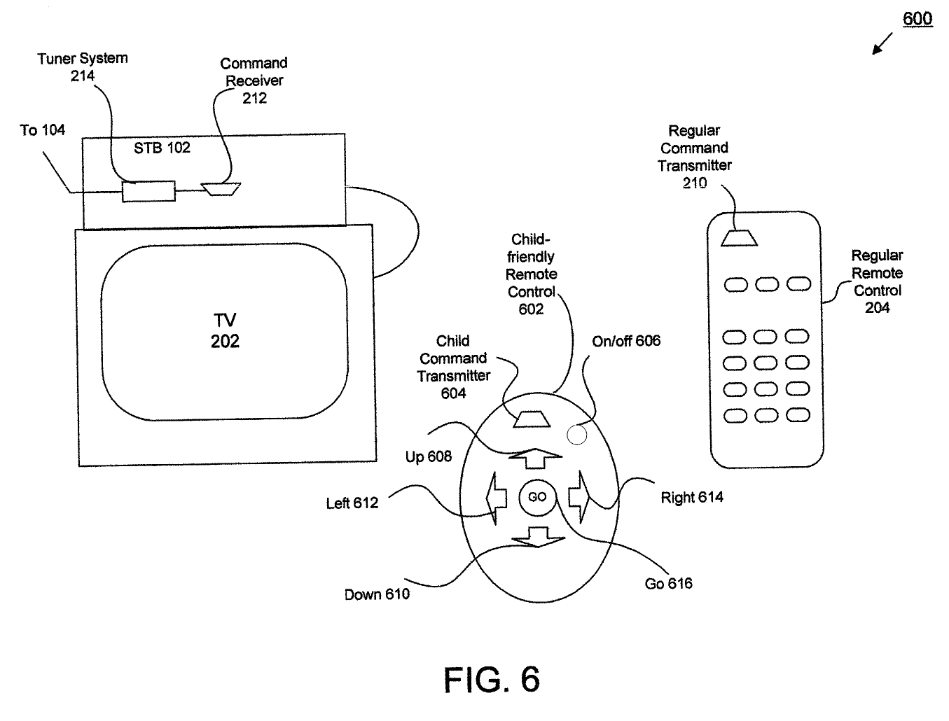

FIG. 6 is an illustration of a first interactive television (ITV) client system in accordance with an embodiment of the invention. In comparison to the ITV client system 200 of FIG. 2, the ITV client system 600 depicted in FIG. 6 includes a child-friendly remote control 602 that is separate and differentiated from the regular remote control 204. Commands are sent to the STB 102 from a child command transmitter 604 embedded in the child remote control 602.

The child-friendly remote control 602 provides a simpler remote control with less buttons than the regular remote control 204. (Recall that the regular remote control 204 depicted in FIG. 6 is simplified and that typical regular remote controls 204 for televisions or set top boxes have substantially more buttons than the one illustrated.) Preferably, the child-friendly remote control 602 will have less than half the buttons on the corresponding regular remote control 204. The child-friendly remote control 602 may, for example, simply include an on/off button 606, up arrow button 608, a down arrow button 610, a left arrow button 612, a right arrow button 614, an “GO” (or “OK”) button 616.

The button set and layout of the child-friendly remote control 602 in FIG. 6 is shown for purposes of illustration and is not intended to strictly limit the scope of the invention. Other sets of buttons and layouts that are also simple and child-friendly may be provided on the child-friendly remote control 602, and such alternate sets and layouts are contemplated to be within the scope of the invention. For example, another configuration of buttons that may be child-friendly is found on the WEEMOTE remote control product of Fobis Technologies, Inc. in Miami, Fla.

The buttons on the remote control 602 are mapped to functionality or activity relating to the ITV client system 600 and particularly relating to the child-oriented electronic program guide. For example, one mapping between buttons and functionality or activity is as follows: the on/off button may activate/deactivate the child-oriented electronic program guide; the up/down arrow buttons may map to louder/softer volume control; the left/right arrow buttons may map to movement across a screen of the child-oriented electronic program guide; and the GO button may map to activating a graphical representation on the screen of the child-oriented electronic program guide. Other mappings between buttons and functionality or activity may be implemented and such alternate mappings are contemplated to be within the scope of the invention. For example, the GO button 616 may be used to turn the child-oriented EPG on, such that the on/off button 606 may be changed to an off button.

The client system 200 may differentiate between commands sent by the regular remote control 204 and the child remote control 602. The differentiation may be accomplished, for example, by differentiating between some or all of the command codes sent by the two remote controls. For example, the on/off button 606 on the child remote control 602 may send a unique command code that is different from the analogous button on the regular remote control 204.

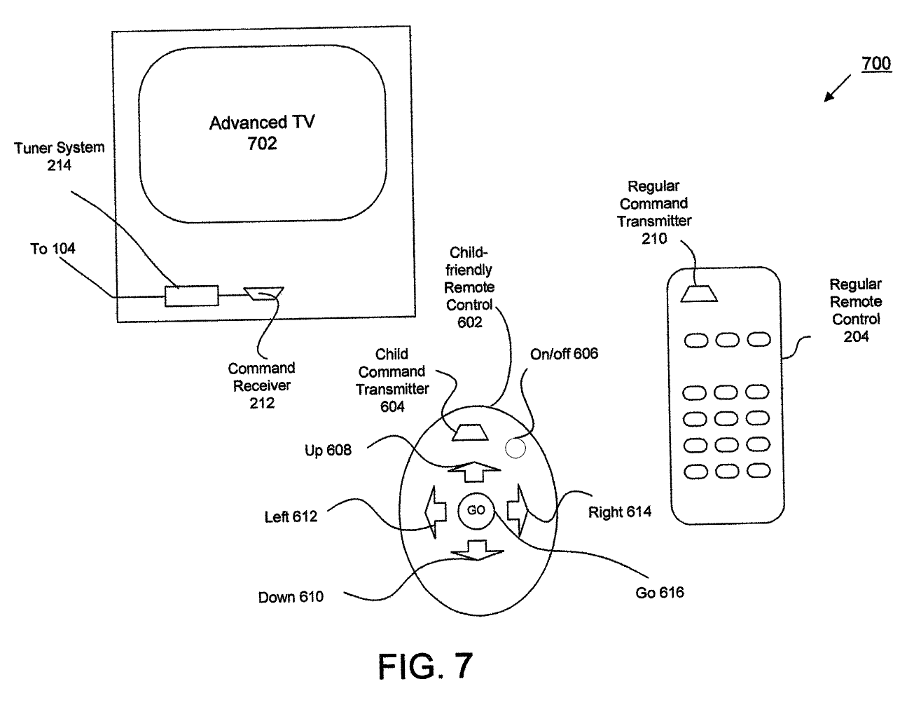

FIG. 7 is an illustration of a second interactive television client system in accordance with an embodiment of the invention. In comparison to the ITV client system 600 of FIG. 6, the IIV client system 700 depicted in FIG. 7 does not include a set top box 102. Instead, the functionality of the set top box 102 is incorporated into an advanced TV 702.

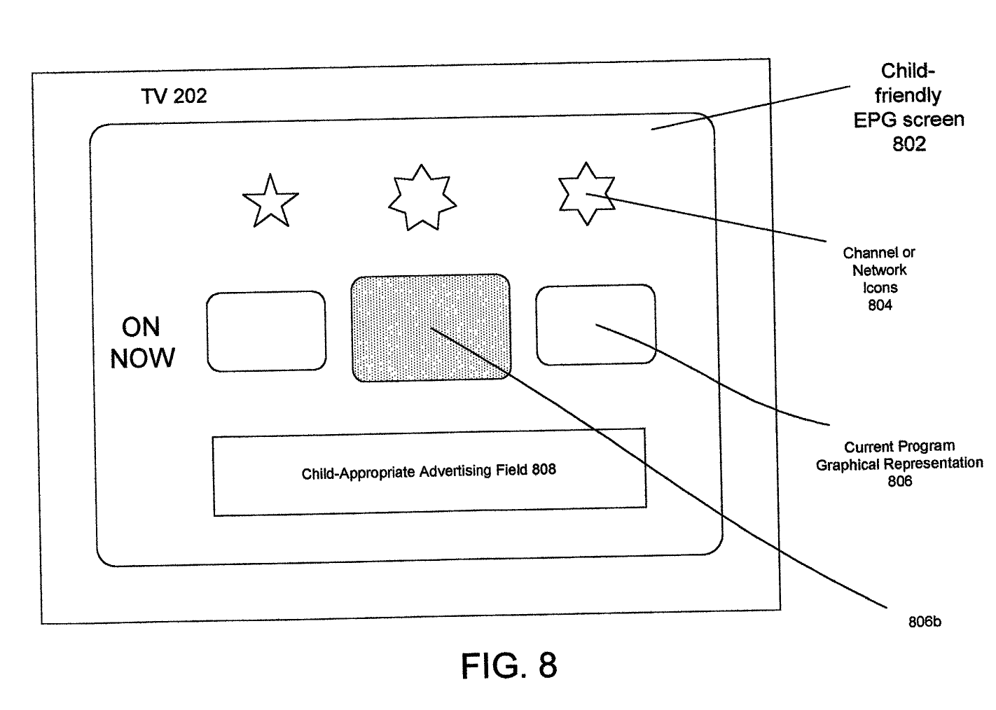

FIG. 8 is an illustration of a television displaying a screen from a child-oriented electronic program guide (EPG) in accordance with an embodiment of the invention. The layout of the child-friendly EPG screen 802 shown in FIG. 8, for purposes of illustration, includes a plurality of channel or network icons 804, a plurality of graphical representations of television programs 806, and optionally one or more advertisements 808. For purposes of generality, the channel or network icons 804 are depicted as star shapes, but they would actually be the recognizable iconic symbols of, for example, FoxKids®, Disney Channel®, Nickleodeon®, and so on. For purposes of generality, the graphical representations of TV programs 806 are depicted as rounded square shapes, but they would actually be the recognizable graphical marks of, for example, Scooby Doo, Winnie the Pooh, Sesame Street, and so on.

In comparison to the regular EPG screen 402 of FIG. 4, the child-friendly EPG screen 802 illustrated in FIG. 8 has substantially less text therein, and the text-therein is displayed in a larger font size. In addition, the child-friendly EPG screen 802 includes more graphical representations of information. For instance, network or station icons 804 may be used to represent channels, so that the channels may be more easily recognizable by a child. In addition, graphical representations 806 may be used to represent the television programs on the channels, so that the programs are more easily recognizable by a child. Further, child-friendly graphics may be optionally used for one or more advertisements 808 on the screen 802. Moreover, the above-described icons, graphical representations, and graphics may be animated and coordinated with audio to increase their child-friendliness or to emphasize them. Such animation may be implemented, for example, using Macromedia Flash®.

Navigation to select a channel may be accomplished using the left/right 612/614 arrow buttons on the child-friendly remote control 602. The currently selected channel may be highlighted, for example, by making the graphical representation larger (see, for example, 806b which is illustrated as larger and filled in), or by animating or otherwise highlighting it. Additional channels may “scroll” onto the screen by navigating “past” the screen edges on the left or right. Activation of a selected channel (to view the current program) may be accomplished, for example, using the GO button 616 on the child-friendly remote control 602.

The particular layout of the child-friendly screen 802 shown in FIG. 8 is provided for purposes of illustration and is not intended to strictly limit the scope of the invention. For example, an additional row of graphical representations of TV programs may be added to show programs available in the next time slot (“ON NEXT”). Other screen layouts with one or more of the same or equivalent child-friendly characteristics may also be used, and such alternate child-friendly screen layouts are contemplated to be within the scope of the invention.

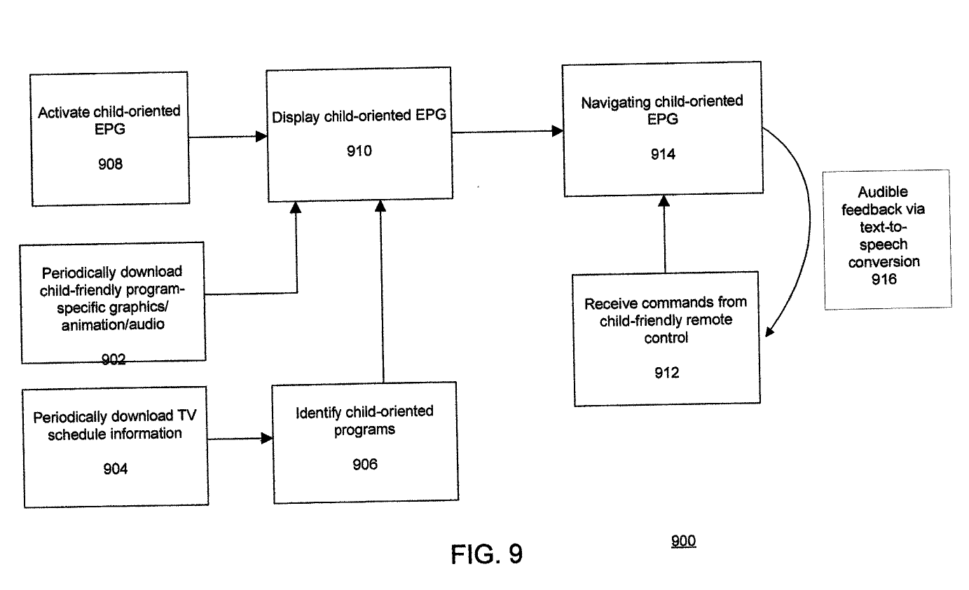

FIG. 9 is a flow chart depicting a method for facilitating a child's selection of a television program for viewing from among available television programs in accordance with the invention. The method 900 shown includes eight steps.

The first step 902 comprises periodically downloading child-friendly program-specific content 502. The program-specific content 502 may originate at a remote source 108. The remote source 108 may provide the content 502 to distribution centers, such as head-ends 104 in a cable network 500, for distribution to set top boxes 102.

The program-specific content 502 may include program-specific graphics, program-specific animation, and/or program-specific audio. Use of the program-specific content 502 is made by the child-oriented EPG subsystem to make child-friendly EPG screens, such as the illustrative screen 802 depicted in FIG. 8. For example, the program-specific content 502 may include the graphical representations of currently broadcast TV programs 806.

The second step 904 comprises periodically downloading TV schedule information 110. Preferably, the second step 904 occurs at the same periodicity as the first step 902. The schedule information 110 may originate at a remote source 108 (that may be the same as the remote source 108 which originates the program-specific content 502). The remote source 108 may provide the schedule information 110 to distribution centers, such as head-ends 104 in a cable network 500, for distribution to set top boxes 102.

In a third step 906, child-appropriate TV programs 906 that are scheduled for broadcast are identified. The third step 906 may be performed by software in a set top box 102, for example, by using content ratings (violence, etc.) provided in the schedule information 110. In that case, the third step 906 would follow the second step 904 (as depicted in FIG. 9). In one embodiment of the invention, a parental control module may be used to add or delete the specific programs presented by the child-oriented EPG. This feature would be a tool for a parent to control or limit the TV programs viewable by the child via the child-oriented EPG.

Alternately, the third step 906 may be performed upstream, for example at the remote source 108, to identify the child-oriented TV programs 906 prior to distribution to the set top boxes 102. In that case, the third step 906 would precede the second step 904 (requiring swapping of second 904 and third 906 steps in FIG. 9).

The fourth step 908 comprises activation of the child-oriented EPG. Activation may be accomplished using a child-friendly remote control 602. In the example child-friendly remote 602 depicted in FIG. 7, the on/off button 606 may be used to activate the child-oriented EPG (and may also turn on the TV). One or more other buttons on a child-friendly remote 602 may instead be used for the activation. In an alternate embodiment, the child-friendly EPG may be the default EPG for the system. In that case, specific activation would be required to activate the regular EPG in order to access the full range of TV programming.

Subsequently, in a fifth step 910, the child-oriented EPG is displayed on the TV screen. In an alternate embodiment, the child-oriented EPG may be displayed on a screen separate from the TV screen. In one embodiment of the invention, a parental control module may be used to restrict time periods during which the child-oriented EPG may be activated. This feature would allow a parent to control the time periods during which a child may use the child-oriented remote control 602 to view TV programming.

A sixth step 912 comprises receiving commands from the child-friendly remote control 602. Upon button presses, the child-friendly remote 602 transmits commands from the child command transmitter 604 to a command receiver 212 in the set top box 102 or advanced TV 702. In an alternate embodiment, the commands may instead be received from the regular remote control 204. In that case, the regular remote control 204 would be used for both the regular EPG and the child-oriented EPG.

Based on the commands received, navigation within and between screens of the child-oriented EPG occurs in a seventh step 914. In one possible implementation described herein, the left/right 612/614 arrow buttons result in movement of a selection rectangle (or other selection means) to different graphical representations of TV programs, and the GO button results displaying on the TV the program corresponding to the selected graphical representation. Other implementations may also be used within the scope of the invention.

In an eighth step 916 which may be optionally implemented in an embodiment of the invention, audible feedback is given as the navigation 914 is performed. The audible feedback may be implemented, for example, using a text-to-speech conversion module.

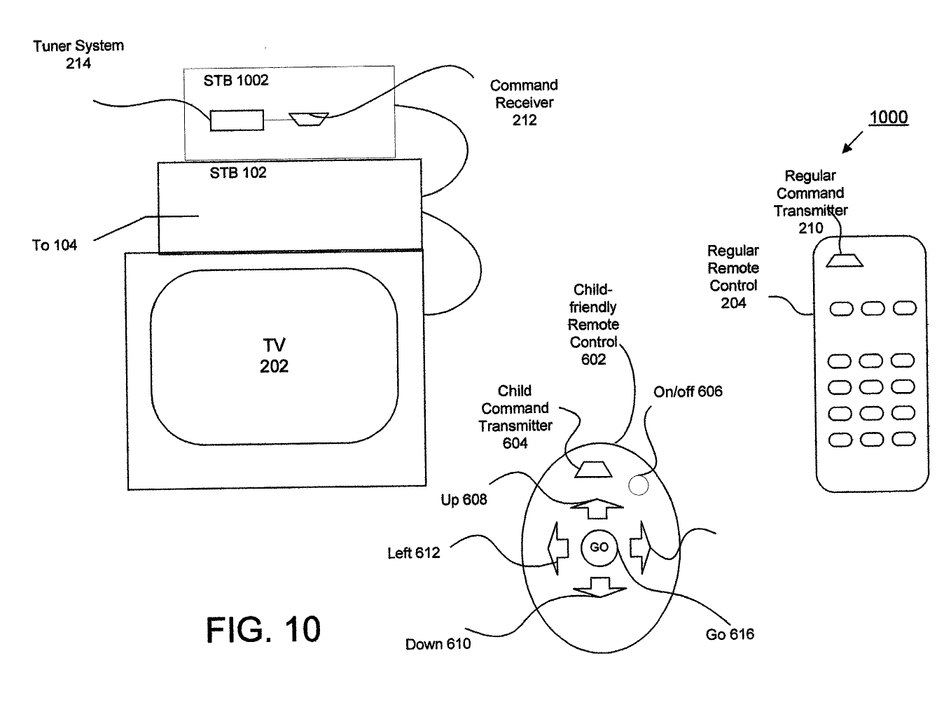

FIG. 10 is an illustration of a third interactive television client system 1000 in accordance with an embodiment of the invention. In comparison to the ITV client system 600 of FIG. 6, the ITV client system 700 depicted in FIG. 10 includes a secondary set top box 1002 coupled to the (primary) set top box 102. The secondary set top box may comprise, for example, a PVR (personal video recorder) device. A conventional PVR device is available, for example, from TIVO Inc. of San Jose, Calif. In the client system 1000 of this embodiment, the child-friendly remote 602 is configured to interact with the secondary STB 1002 to activate and control the child-oriented EPG.

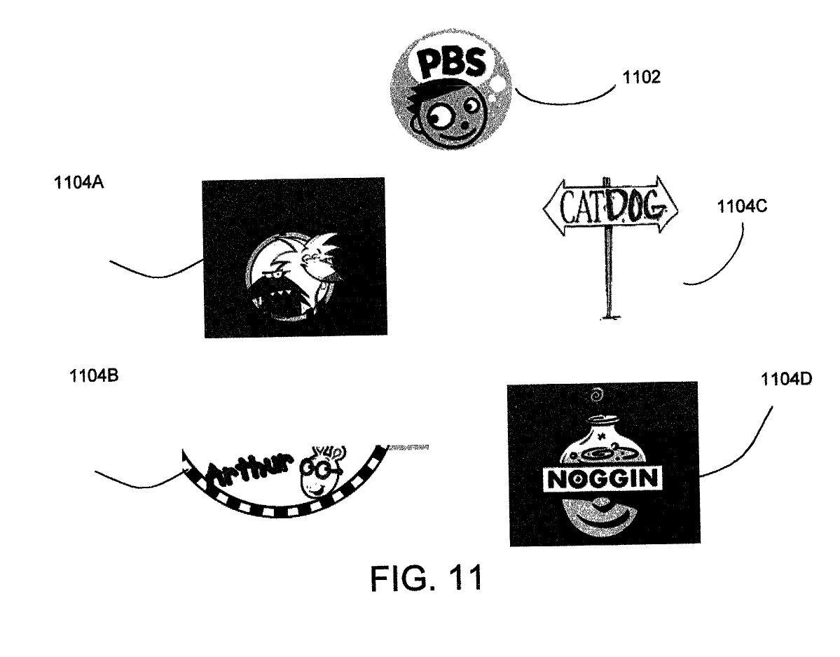

FIG. 11 depicts example graphical icons for use in a child-oriented electronic program guide in accordance with the invention. A first graphical icon 1102 depicts PBS KIDS and provides an illustrative example of a network or channel icon 804 that may be used in the child-oriented EPG screen. The four other graphical icons 1104A, 1104B, 1104C and 1104D depict THE ANGRY BEAVERS, ARTHUR, CATDOG, and NOGGIN, respectively. These four graphical icons 1104A-D provide illustrative examples of graphical representations of television programs 806 that may be used in the child-oriented EPG screen.

The above description of illustrated embodiments of the invention is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

For example, embodiments of the invention include modification from a child-oriented EPG to a pre-teen or teen oriented EPG. In this respect, the invention may apply to minor-oriented EPGs in general.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

What is claimed is:

1. A system for providing an electronic guide to television programs, the system comprising:
a regular guide subsystem for providing schedule information for available broadcast programs; and
a child-oriented guide subsystem for providing schedule information for child-appropriate broadcast programs,
wherein the child-oriented broadcast programs are a subset of the available broadcast programs.

2. The system of claim 1 wherein the child-oriented guide subsystem displays the schedule information in a larger font size than a font size used to display the schedule information by the regular guide subsystem.

3. The system of claim 1 wherein the child-oriented guide subsystem displays program-specific child-friendly graphics correlated with the schedule information.

4. The system of claim 3 wherein the child-oriented guide subsystem further displays program-specific child-friendly animation correlated with the schedule information.

5. The system of claim 4 wherein the program-specific child-friendly graphics and animation are periodically downloaded by the system from a remote source.

6. The system of claim 1 wherein the child-oriented guide subsystem provides audio-feedback in reaction to selective button presses on a remote control.

7. The system of claim 1 further comprising:
a parental control module to customize a configuration of the child-oriented guide subsystem by changing (adding or deleting) specific programs presented by the child-oriented guide subsystem.

8. The system of claim 1 comprising:
a parental control module to customize a configuration of the child-oriented guide subsystem by restricting time periods during which the child-oriented guide subsystem may be activated.

9. The system of claim 1 further comprising:
a child-oriented remote control for activating the child-oriented guide subsystem and for providing commands to the child-oriented guide.

10. The system of claim 9 wherein the child-oriented remote control includes fewer and larger buttons than a regular remote control for the system.

11. The system of claim 1 wherein the child-oriented guide subsystem displays child-appropriate advertising which differs from advertising displayed by the regular guide subsystem.

12. The system of claim 1 wherein the child-oriented guide subsystem displays time slots in relation to the current time while the regular guide subsystem displays time slots in terms of the time of day.

13. The system of claim 1 further comprising:
a text-to-speech module utilized by the child-oriented guide subsystem to produce audible speech renderings of selective text information displayed by the child-oriented guide subsystem.

14. The system of claim 1 wherein the child-oriented guide subsystem displays child-friendly background graphics and audio that differs from the background graphics and audio displayed by the regular guide subsystem.

15. The system of claim 14 wherein the child-friendly background graphics and audio are periodically downloaded by the system from a remote source.

16. The system of claim 1 wherein the schedule information for available broadcast programs and the schedule information for the child-appropriate broadcast programs are downloaded periodically by the system from a remote source of schedule information.

17. The system of claim 1 further comprising:
a pre-teen-oriented guide subsystem for providing schedule information for pre-teen-oriented broadcast programs,
wherein the pre-teen-oriented broadcast programs are a subset of the available broadcast programs.

18. The system of claim 1 further comprising:
a teen-oriented guide subsystem for providing schedule information for teen-oriented broadcast programs,
wherein the teen-oriented broadcast programs are a subset of the available broadcast programs.

19. The system of claim 1 further comprising:
a ratings-based blocking module under parental control for automatically blocking objectionably-rated broadcast programs from being viewable by way of the child-oriented guide subsystem.

20. The system of claim 1 wherein the system is implemented using a set top box and software therein.

21. A processor-readable memory, the memory comprising:
processor-readable instructions for providing a regular electronic program guide to schedule information for available broadcast programs; and
processor-readable instructions for providing a minor-oriented electronic program guide to schedule information for minor-appropriate broadcast programs,
wherein the minor-appropriate broadcast programs are a subset of the available broadcast programs.

22. The memory of claim 21 further comprising:
processor-readable instructions for periodically downloading minor-appropriate graphics and animation for display by the minor-oriented electronic program guide.

23. The memory of claim 21 further comprising:
processor-readable instructions for receiving commands from a minor-oriented remote control and for applying the commands to control and navigate within the minor-oriented electronic program guide.

24. The memory of claim 21 further comprising:
processor-readable instructions for text-to-speech conversion to produce audible speech renderings of selective text information displayed in the minor-oriented electronic program guide.

25. The memory of claim 21 further comprising:
processor-readable instructions for blocking objectionably-rated broadcast programs from being viewable by way of the minor-oriented electronic program guide.

26. The memory of claim 21 wherein the memory is located within a client device from the group of client devices including a set top box and an advanced television.

27. An electronic program guide for providing schedule information on broadcast programs, the electronic program guide comprising:
a regular guide portion for providing schedule information on a full range of available broadcast programs; and
a minor-oriented guide portion for providing schedule information on a narrower range of minor-appropriate broadcast programs.

28. The electronic program guide of claim 27 wherein the electronic program guide periodically downloads minor-appropriate graphics and animation for display by the minor-oriented guide portion.

29. The electronic program guide of claim 27 wherein the minor-oriented guide portion is configured to be activated and controlled by a separate remote control, apart from the regular remote control.

30. The electronic program guide of claim 27 wherein the minor-oriented guide utilizes text-to-speech conversion to produce audible speech renderings of selective text information displayed in the minor-oriented guide portion.

31. The electronic program guide of claim 27 wherein the minor-oriented guide utilizes ratings-based blocking for blocking objectionably-rated broadcast programs from being viewable.

32. The electronic program guide of claim 27 wherein the electronic program guide is configured for use with a client device the group of client devices including a set top box and an advanced television.

33. A method for facilitating and controlling a child's selection of a television program for viewing from among available television programs, the method comprising:
activation of a child-oriented electronic program guide which displays schedule information for child-appropriate television programs and hides schedule information for other television programs;
display of the child-oriented electronic program guide which includes child-friendly graphics and audio; and
navigation of the child-oriented electronic program guide to select a particular child-appropriate television program for viewing by the child.

34. The method of claim 33 wherein child-friendly graphics and animation are periodically downloaded from a remote source.

35. The method of claim 33 wherein activation and navigation of the child-oriented electronic program guide is accomplished by receiving commands from a child-oriented remote control that is separate from a regular remote control.

36. The method of claim 33 further comprising:
converting selective text information to audible speech renderings to facilitate the navigation of the child-oriented electronic program guide.

37. The method of claim 33 further comprising:
utilization of ratings-based blocking to eliminate objectionably-rated broadcast programs from the child-oriented electronic program guide.

38. A system for providing an electronic guide to television programs, the system comprising:
regular guide means for providing schedule information for available broadcast programs; and
child-oriented guide means for providing schedule information for child-appropriate broadcast programs,
wherein the child-oriented broadcast programs are a subset of the available broadcast programs.

39. A system for facilitating and controlling a child's selection of a television program for viewing from among available television programs, the system comprising:
means for activating a child-oriented electronic program guide which displays schedule information for child-appropriate television programs and hides schedule information for other television programs;
means for displaying the child-oriented electronic program guide which includes child-friendly graphics and audio; and
means for navigating the child-oriented electronic program guide to select a particular child-appropriate television program for viewing by the child.

40. An electronic program guide for providing schedule information on broadcast programs, the electronic program guide comprising:
a regular guide portion for providing schedule information on a full range of available broadcast programs; and
a minor-oriented guide portion for providing schedule information on a narrower range of minor-appropriate broadcast programs,
wherein the electronic program guide periodically downloads minor-appropriate graphics and animation for display by the minor-oriented guide portion,
wherein the minor-oriented guide portion is configured to be activated and controlled by a separate remote control, apart from the regular remote control, and
wherein the electronic program guide is configured for use with a client device the group of client devices including a set top box and an advanced television.
